(19) United States
(12) Patent Application Publication
(10) Pub. No.: US 2004/0093360 A1
(43) Pub. Date: May 13, 2004

(54) System and method for transferring data between recording devices

(76) Inventor: Kevin D. Hudson, Half Moon Bay, CA (US)

Correspondence Address: Ampex Corporation, 1228 Douglas Avenue, Redwood City, CA, 94063, US

(21) Appl. No.: 10/398,347

(22) PCT Filed: Oct. 9, 2001
(86) PCT No.: PCT/US01/42571

(30) Foreign Application Priority Data
Oct. 6, 2000 (US) 60238765

(51) Int. Cl. G06F 12/16

(52) U.S. Cl. 707/204; 711/161

(57) ABSTRACT

A system and method for enabling transfer of data from one recording media to another while preserving the original context is provided. An application operating on a host computer communicates with an acquisition recorder and an archive recorder. The application reads file and event information on the acquisition recorder and creates a leader on the archive recording medium that identifies the acquisition recording as such. Next file directory data and special event marker (SIM) data are created. Fmally record data, comprising the data from the acquisition recorder, is written to the archive media. Typically, file and event directory descriptors are taken from the acquisition recorder format when the application is adapted to recognize such descriptors. The application is also adapted to create appropriate file directory descriptors for transmisssion over the acquisition control interface when the acquisition directory descriptors cannot be used by the application. The application is also adapted to enable playback of the archive media in a form similar to the original acquisition context/storage arrangement.

### BACKGROUND OF THE INVENTION

Field of the Invention

This invention relates to data recording devices, and more particularly to systems and methods for transferring data between recording devices.

Background Information

Solid state recording devices are used increasingly for a variety of tasks including video surveillance, sound recording, time-based telemetry recording (e.g. flight data recorders, seismographs, etc.) and other mass-data-storage operations, time-based and otherwise. Solid state recording devices typically exhibit limited storage capabilities albeit large (several gigabytes), and are often dedicated to certain locations such as a camera hookup or instrument pack. Accordingly, the ability to transfer data from a solid state “acquisition” medium to a fixed high-volume “archive” medium, such as magnetic tape is highly desirable. Once a transfer occurs, the data storage memory of the solid state recorder can be freed for further recording, and the transferred data therefrom can be analyzed, processed, and long-term stored for later review.

Transfer of data from one medium to, another, or one recording device to another, sometimes has disadvantages. Often the inherent structure of the two devices, and the associated differences in storage and formatting of data in the two devices leads to difficulties in accessing and manipulating the data in each device. For example a solid state recorder may be controlled by a particular application, and thereby lay down data in a specific file format and directory structure (e.g. the “context”). This context can include various benchmarks of key data within the time base that point to important recording events. Such benchmarks can be provided by an operator observing the events or based upon automatic criteria such as sensor triggers or time-dependent triggers. The benchmarked events can become part of specific directories that are discretely identified and reviewable by an operator. In general, the chosen file format and directory structure used by the solid state recorder is readily recognized by the application controlling the solid state recorder. This enables an operator to easily review and manipulate desired parts of the solid state recorder data while it resides on the solid state recorder via graphical user interfiae or other device that works in conjunction with the application.

However, when the data on the solid state recorder is subsequently transferred to a tape drive (for example, a rotating trasverse scan head drive), the taped format may differ substantially, and the directory information may become unrecognizable to the solid state recorder application. At the very least, the data may become difficult to access as the event benchmarks from the solid state recording may not be properly accounted for with reference to the new tape format This makes retrieval of specific tracks and events on the tape difficult, and may require the user to manually scan the tape for various key information/events.

Accordingly, it is an object of this invention to provide a system and method for enabling transfer of data from a solid state (or other) recording medium to another new medium while preserving its context so as to enable the user to easily review and manipulate the transferred data on the new medium based upon the context established in the old medium. This system and method should enable transfers of data between a variety of different mediums and formats without loss of relevant directory and other identifying information for the data. This system and method should also be relatively easy to use and allow quick review and manipulation of transferred data in the new medium/format.

### SUMMARY OF THE INVENTION

This invention overcomes the disadvantages of the prior art by providing a system and method for enabling transfer of data from an acquisition recording media to another archive media that preserves the original context of the acquisition recording media for easier access and playback. An application, operating on a host computer, communicates with an acquisition recorder and an archive recorder. The application reads file and event information on the acquisition recorder and creates a leader on the archive recording medium that identifies the acquisition recording as such. Next file directry data and special event marker (SIM) data are created. Finally, the record data, comprising the data from the acquisition recorder, is written to the archive media Typically, file and event directory descriptors are taken from the acquisition recorder format when the application is adapted to recognize such descriptors. The application is also adapted to create appropriate file directory descriptors for transmission over the acquisition control interface when the acquisition directory descriptors cannot be used by the application. The application is also adapted to enable playback of the archive media in the same form as the original acquisition context/storage arrangement.

The record data is preferably non-zero in length so as to conserve recording resourses. The data may have a zero length because it originates from an acquisition media file in which data was not recorded due to operator intervention at original acquisition, or during the transfer from one media to another. In this manner, identifiers for blocked, or otherwise non-transferred data, are omitted, thus conserving media space.

In a preferred embodiment, the acquisition recorder is a solid state recorder (SSR) having a solid state memory with a control interface compatible with the host computer. The archive recorder is a transverse scan digital cartridge tape recorder (DCR), also having a control interface adapted to communicate with the host computer. The application includes drivers for recognizing and communication with both control interfaces. The SSR and DCR are interconnected during data transfer by a data line, such as an 8-bit parallel line interconnected with each of a pair of respective data ports.

The archive media (tape) includes information indicating the presence of speciftc acquisition-format data therein. This information includes two parts. A first part is a leader that is recorded with the indicated data as a preamble to the data. The second part is recorded synchronously with the indicated data in a longitudinal track on the media separate from the track along which the indicated data is recorded. During archive playback, this information prompts the application to enter retrieval mode. In this mode, playback according to acquisition time stamps, events and other criteria is supported by the application via its associated graphical user interface operating on the host computer. The host computer can be a separate unit, or can be physically located in either the archive recorder or acquisition recorder.

### BRIEF DESCRIPTION OF THE DRAWINGS

The foregoing and other objects and advantages of the invention will become clearer with reference to the following detailed description as illustrated by the drawings in which:

FIG. 1 is a schematic perspective view of the acquisition and recording of video data by an acquisition solid state recorder (SSR) according to an exemplary embodiment of this invention;

FIG. 2 is a schematic perspective view of a basic setup for transferring data from the acquisition SSR to an archive medium tape recorder according to an exemplary embodiment;

FIG. 3 is a schematic perspective view of the control and playback of archive data from the tape recorder according to an exemplary embodiment;

FIG. 4 is a plan view of a graphical user interface screen for a host data transfer application according to a preferred embodiment;

FIG. 5 is a plan view of a graphical user interface screen for enabling control of the SSR via the host computer application according to thepreferred embodiment;

FIG. 6 is a plan view of a graphical user interface screen for directing the dub of data from the SSR to the tape recorder for the host computer application according to the preferred embodiment;

FIG. 7 is a flow diagram of a generalied control procedure for the host computer application according to the preferred embodiment;

FIG. 8 is a flow diagram of the generation of directory descriptors for use with the host computer application according to the preferred embodiment;

FIG. 9 is a plan view of a graphical user interface screen for controlling play-back of the archive data according to the original SSR file scheme; and

FIG. 10 is a flow diagram of the archive playback procedure according to a preferred embodiment.

### DETAILED DESCRIPTION OF AN ILLUSTRATIVE EMBODIMENT

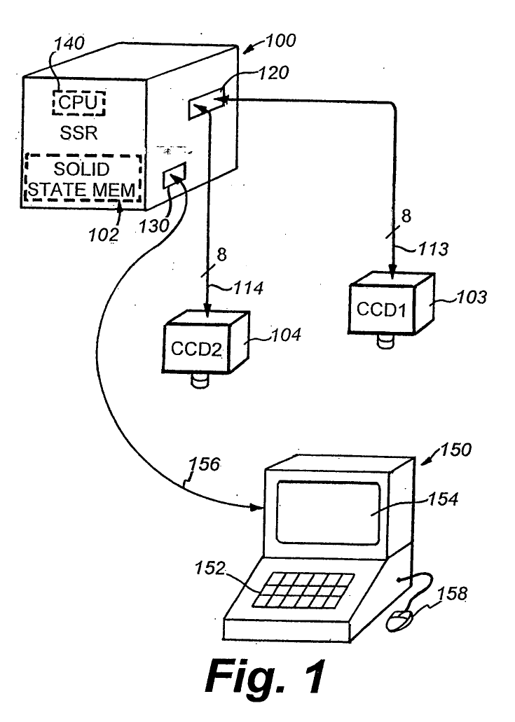

FIGS. 1-3 show schematically the acquisition, transfer to archive medium, and playback of archived data, respectively, according to an exemplary embodiment of this invention. The acquisition device and archive device described herein are, respectively, a solid state recorder and a transverse scan, rotary head digital tape recorder. However, it is expressly contemplated that the principles described herein are applicable to a variety of acquisition and archive devices. For example the acquisition device can be a transverse scan, rotary head digital tape recorder while the archive device can be an optical disk recorder or helical wrap digital tape recorder.

In general, this exemplary description relates to the acquisition.of original data using a solid state recorder (SSR) 100. For the purposes of this description, the SSR can be an S/TAR or SSRS unit commercially available from Ampex Corporation of Redwood City, Calif. This recorder includes a solid state, non-volatile memory 102 currently having a variable size of between 8GBytes and 100 GBytes, typically provided as removable memory cartridges. The SSR shall also be termed the “acquisition” recorder indicating that it is the original source of the data, and can be substituted by any other type of recording device (solid state, tape, magnetic disk, optical or otherwise) that stores data in a particular context.

The illustrated example in FIG. 1 shows the SSR 100 interconnected to two charge couple device (CCD) camera assemblies CCD1 (103) and CCD2 (104), each having appropriate internal processor/image acquisition hardware and firmware (not shown). Each camera delivers video data over an 8-bit parallel data line 113 and 114, respectively to a parallel port 120 on the SSR Alternatively, a variety of other ports and associated data forms (such as serial and/or optical) can be used. Appropriate interfaces are provided for other forms in association with the SSRP. While a pair of cameras are the exemplary data acquisition devices herein, it is expressly contemplated that a variety of different types of data acquisition devices including audio devices, telemetry devices, remote sensors and the like can be employed in a variety of combinations. Likewise, the use of two “volumes” of data, each associated with a discrete device (camera) is exemplary. The SSR can be adapted to receive one volume, two volumes, or more than two volumes of acquisition data according to-various embodiments of this invention.

A control port 130 (RS232, RS422, etc.) is interconnected with an on-board central processing unit (CPU) 140 that controls internal data storage functions and memory access. In addition a remote interface unit comprising, in one embodiment, a microcomputer 150, with keyboard 152 and interface screen 154 can be interconnected via a data line 156 to the port 130. The computer 150 is adapted to run a control application that enables the user to operate the SSR so as to variably record and store data, and flag certain events along the recording time base for special interest. The screen 154 can display a graphical user interface according to a Microsoft Vmdows® format, or another acceptable display pattern. A touch screen or mouse 158 can also be used to interact with the interface. In this manner, original acquisition data is recorded on the solid state memory 102 by the operator.

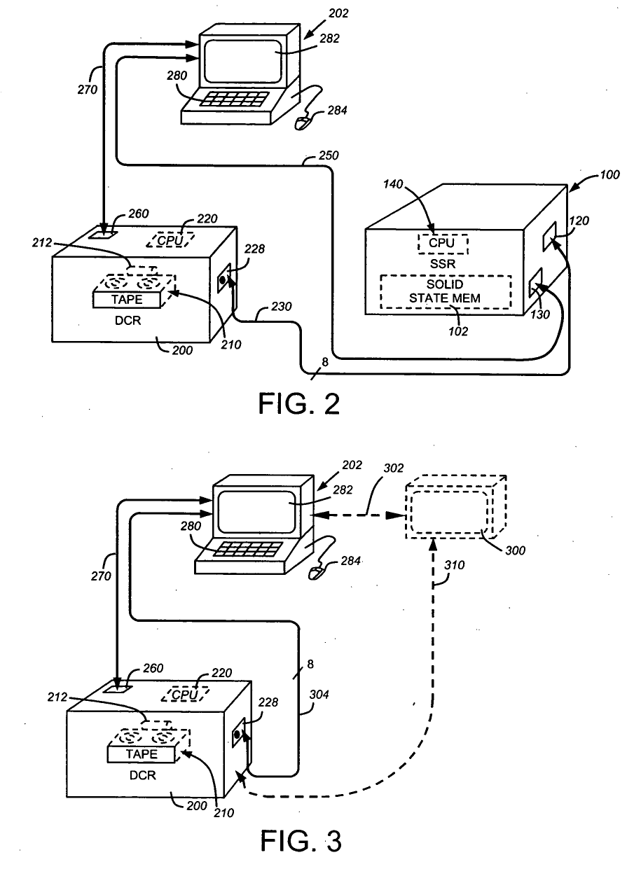

Referring to FIG. 2, once data has been recorded on the SSR 100, the SSR, or a subcomponent containing its memory 102, are interconnected with a digital cartridge tape recorder (DCR) 200 and host computer 202 according to this exemplary embodiment. The exemplary digital earridge tape recorder (also termed simply “recorder”) of this embodiment is a DCRsi® digital tape cartridge recorder, specifically a DCRsi® 240 tape cartridge recorder, also available from Ampex Corporation of Redwood City, Calif. DCRsi® is a registered trademark of Ampex Corporation, and all rights therein are reserved. The DCRs® recorder is configured as a one-inch tape, tsverse scan, rotary head digital tape cartridge recorder having a data rate generally from 0-30 Mbytes/sec. The tape has a capacity of approximately 50 GBytes of data.

Briefly summarized, a transverse scan tape recorder uses a rotating record head having an axis of rotation parallel to the longitudinal (movement) direction of the tape and rotating to lay a series of evenly spaced tracks transverse (perpendicular) to the longitudinal direction. The tracks are located within the central portion of the tape, while the tape opposing edges surrounding the central portion contain various control and identifier data (audio, telemetry, etc.) laid down continuously in a series of parallel longitudinal strips by other record/erase heads.

The DCR can also be termed the “archive” recorder as it stores a longer-term archive of the data from the SSR acquisition recorder on appropriate media. The acquisition recorder can be any acceptable -data-recording device, including one utilizing solid state, tape, magnetic disk, optical or other storage media

The DCR 200 houses a tape cartridge 210 that is written upon by a head assembly 212 of conventional design. A CPU220 controls internal reading, writing and advance of the tape as well as other functions. An internal data buffer (not shown) is typically provided to buffer data read from and/or written to the tape. The data port 120 on the SSR 100 is interconnected to the DCR's associated 8-bit data port 228 via an 8-bit data line 230. This forms a data bridge between the solid state memory and tape head assembly via respective CPUs 140 and 220. The control port 130 on the SSR is likewise connected with a port on the host computer 202 via a control line 250. Another control port 260 on the DCR (RS232, RS422, etc.) is also interconnected with the host computer 202 via another control line 270.

The host computer includes a keyboard 280, display 282 and other interfaces (mouse 284) for manipulating a host application resident in the computer 202. The screen displays an appropriate graphical user interface described further below. The application is based generally upon an existing control application for the DCRsi® recorder. It can be loaded on a standard microcomputer or work station having an appropriate operating system using a magnetic or optical disk. The host computer can be adapted to utilize standardized and/or existing bus and interface ports (serial and parallel COM ports). Where necessary, a specialized interface card with multiple data/control ports and associated adapter firmware is also provided to the host computer 202 to interface with the DCR 200.

Briefly referring to FIG. 3, the archive data stored on the DCR tape can be accessed and reviewed asif it were still resident on the acquisition SSR using the application on the host computer 202 according to this invention. The SSR has been disconnected, leaving the host computer 202 interconnected with the DCR 200. For the purposes of this example the sarne host as in the data transfer of FIG. 2 is employed. However, a different host runing the archive-retrieval application of this embodiment, or a different DCR and appropriately programmed host, using only the archive tape 210 can be employed. In other words the archive tpe can be stored for later use and played on another DCR setup so long as the host contains.the appropriate application for recognizing the original SSR data format This is described in detail below. The playback can be viewed on the display 282 of the host or on a separate monitor 300 (shown in phantom). The data from the tape can be delivered to the monitor through the host via a line 302 based upon the 8-bit line 304 interconnected with the DCR 200. Alternatively a direct data link 310 can be established with the monitor 300 using appropriate drivers in the monitor or DCR to translate the data on the tape into a viewable format In each case, the control line 270 enables the application on the host to control access and playback of tape data on the DCR.

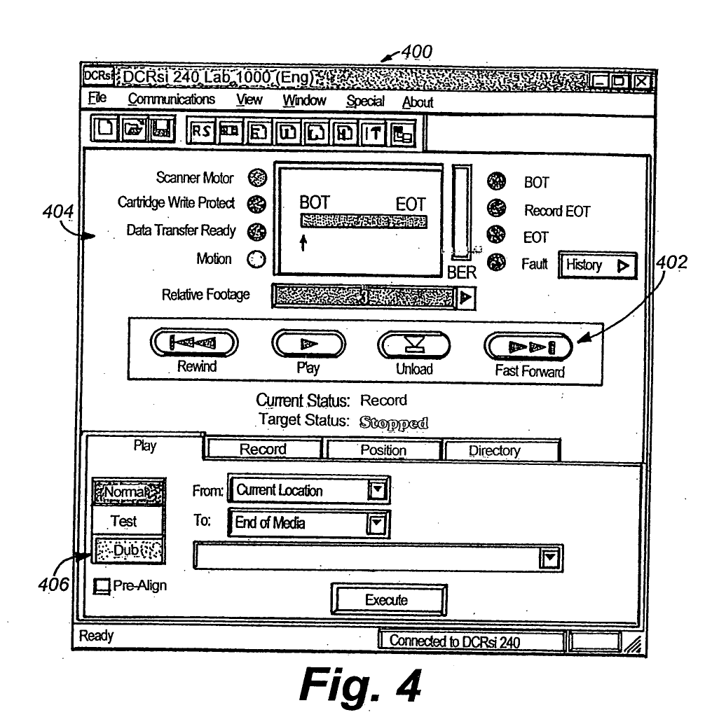

Referring now to FIGS. 4-7 the transfer of data from the SSR to DCR is described in further detail. FIG. 4 shows a graphical user interface screen based upon the commercially available DCR Panel computer application available from AmpexCorporation. In general, the modified application includes specialized drivers adapted to recognize data from the SSR, being originally designed to control and operate the DCR control interface via the DCR CPU through the control line 270.

The application on the host computer responsible for the recorder interface provides a graphical user interface screen 400 according to an embodiment of this invention. This graphical user interface is responsible for control of the DCR during normal operation Note that it includes various play and advance control buttons 402 in the manner of a standard tape drive. Accordingly, the transfer of data from the SSR memory to the DCR cartridge is easily accomplished. The DCR and SSR recorders support several features to simplify this transcription process. In particular, the SSR recorder supports the transfer of its internal directory information across the data port allowing the SSR directory information as well as the SSR data to be transferred directly to the DCR tape. This directory information defines the context of the acquired data set. In other words, the directory information describes the individual recorded files along with the time-stamping of the acquired data. In addition, the SSR supports tagging of data or “special interest marks” (SIMs), the location of which special events is also described in the SSR directory. By trnnsferring the directory and data to the DCR cartridge, the context of the original acquisition is preserved allowing the data to be referenced relative to its initial acquisition as noted above, anew driver is provided to the application so that the DCR application recognizes the presence of the SSR The driver also enables control information to be passed between the host computer and SSR control interface via the control line 250. By way of example, the modified graphical user interface includes a data transfer status indicator 404. Note also that a dub control button 406 is provided relating to the transfer of data between the SSR and DCR.

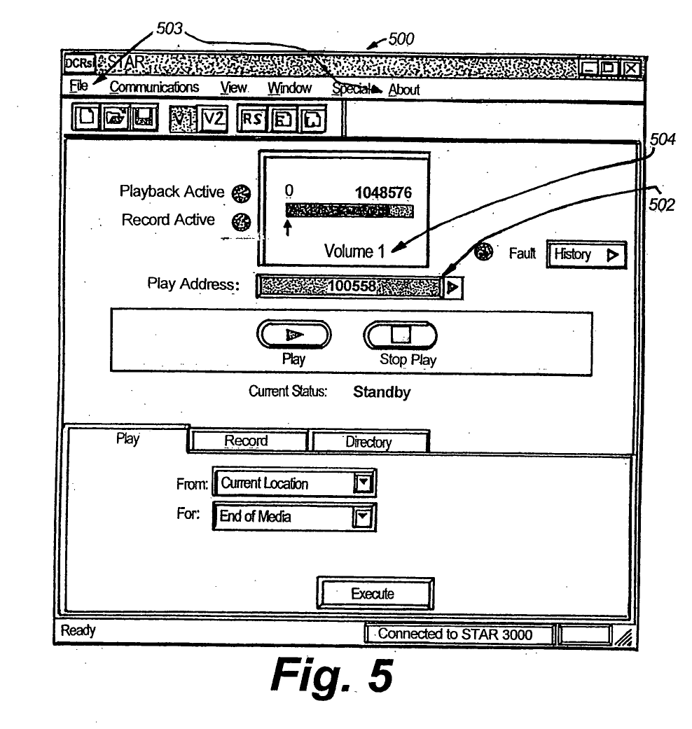

FIG. 5 shows a graphical user interface screen 500 relating to the SSR control mode in the application. Using this interface screen, the application enables the basic control of SSR functions including record, play-from-an-address (window 502), play-a-directory of the SSR and erase SSR memory. Certain functions, such erase SSR memory can be accessed using one of the pull-down menus (“File,” for example) at the upper menu bar 503 ofthe screen. By accessing directory information, the application enables other operations such as play-from-a-time-code, play-from-a-SIM and play-by-a-file number. Since the SSR in this example is configured with at least two input is ports, the SSR memory is divided into two discrete volumes-one associated with each port. The window 504 indicates that Volume 1 is currently active. The application enables the user to select between volumes so as to control playback of each volume in dependently.

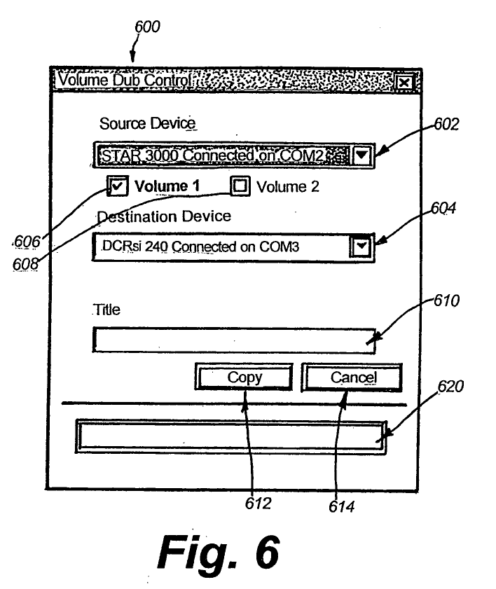

As noted above, a dub control window has been added to the application graphical user interface to control and monitor traser of data from the acquisition recorder to the archive recorder. The dub control window 600 is shown in FIG. 6. The window includes a selectable data source device menu 602 (the SSR in this example) and a selectable data destination device menu 604 (the DCR in this example). The selection of separate volumes is made in boxes 606 and 608. Both volumes can be selected simultaneously for transfer for a single volume can be selected. A title box 610 is also provided to enable the user to specify a general title for the copied data on the DCR tape. The title can be written to the DCR tape as user log data or as longitudinal data along the tape itself at an appropriate strip position. Copy and cancel buttons 612 and 614 respectively are provided to begin the dubbing process and, if desired, cancel it.

The data transfer from the SSR (acquisition recorder/media) to the DCR (archive recorder/media) will now be described. In general, when data is transferred from the SSR to DCR, the data is trasferred using a fixed format on the cartridge tape. Note that the raw data (video, audio, etc.) transferred over the 8-bit line is not converted to another format by the host application. Rather, the data retains its original format As such, playback and data-display devices, such as the monitor 300 (FIG. 3), include an appropriate data converter that recognizes the raw data form. The converter for playing back and/or displaying data from the SSR may differ from that of a DCR. When playing back and displaying the archived data, the monitor may, therefore, include a converter for the SSR. The application enables the various control context on the transferred data to be maintained with respect to the SSR.

A short leader is first wntten to the tape to guarantee that the user log data identifying the tape as an SSR copy will be recoverable. Then, the directory information for each volume (two volumes in this example) is written to the tape in four separate recordings. There is one file directory recording and one SIM directory for each volume. The four directory recordings are, as a rule, written to the tape (archive media) as a leader to keep the data format on the tape consistent. If there is no directory information for one of the associated volumes, then the leader is written on the tape for the volume with the missing directory information, but no data is written on the tape for that volume. Then, each individual file, with a record length greater than zero is written as a separate file on the DCR tape. In other words, the number of individual records written to the tape is one for the leader, four for the directory data; and one for each non-zero length file on the SSR. The dub control window (FIG. 6) displays the current status of the dub process while the operation is in progress. This is reported at box 620 in the control window 600.

Note that a non-zero-length record is specified. In certain instances data may not be recorded on the acquisition media for a given recorded file and associated event identifiers. This may occur when the operator intervenes to block the recording of data that was to be identified by the record identifiers. To avoid unnecessary consumption of archive media volume, the file and event identifiers associated with the acquisition media regions having no recorded data are not subsequently recorded onto the archive media during the data transfer from the acquisition media to the archive media. In addition, an operator may intervene during the particular data transfer process between acquisition and archive to block the transfer of selected data to archive. Therefore, unnecessary consumption of archive media volume is avoided by not recording on the archive media the identifiers associated with the blocked data.

More specifically, the transfer of data from the SSR to the DCR involves three primary steps. Each step writes an essential part of the SSR acquisition data to the DCR archive tape. The first step involves an identifier describing the transcription it-self namely, the type of data transferred and in what format it is transferred to. The second step involves the directory description of the original data sent relative to its initial acquisition and storage on the SSR. This directory description defines the context of the original data sent. The third step involves the original data sent from the SSR to the DCR.

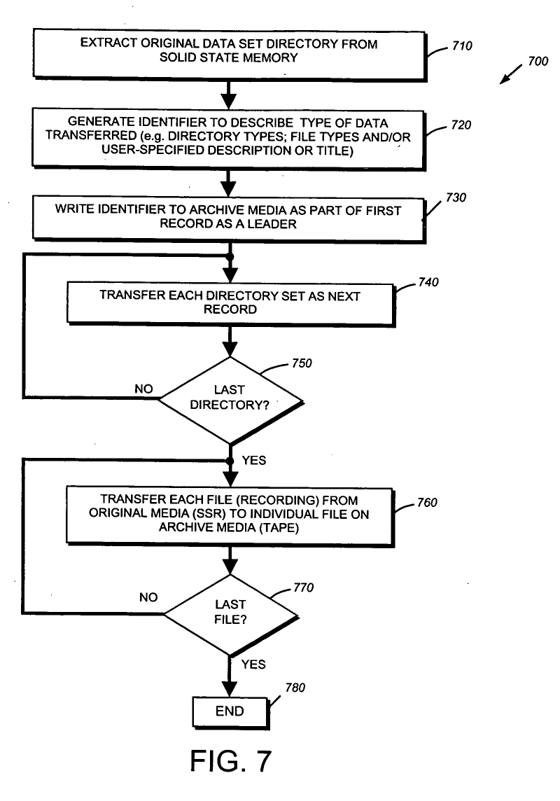

FIG. 7 describes the general procedure 700 for transfer of data between acquisition and archive recorders. According to step 710, the original data set directory is first extracted from the SSR (acquisition recorder/media). This involves reading the data through a conventional addressing and transmit process using the modified control driver in the application to “play” the solid state recording data over the 8-bit line. The original directory defines the context of the acquired data including its location in the transferred acquisition data set by address, time stamp of the data and the location of any special event or interest marks (SIMs). Next, according to step 720 an identifier that describes the type of data transferred (i.e. directory types, file types and/or user-specified descriptor or title) is generated by the application. This is accomplished by reading the existing identifiers in the acquisition data set and associating appropriate application-recognized identifiers to it. Next, in step 730 the application writes the identifier unique to the DCR archive recording. This can be a particular file or directory name. This identifier is used by the application algorithm to recover the original data once it is recorded on tape.

Each directory type (i.e. file directory and SIM directory) is written to a separate file of known characteristics-such as anidentifier comprising a particular value for data length defined in the DCR tape identifier record. Each directory set is accordingly sent in sequence, as shown in step 740. Note thatthe directory descriptors can be transferred directly from the original SSR media, or they can be generated by and transferred from the host application itself. This procedure is described furher below. Once each directory set has been transferred onto the archive tape, the decision step 750 branches to step 760. Otherwise, directory set trnsfers continue in sequence according to step 740 until the last directory set is trnnsferred.

According to step 760, each file record is then transferred in its entirety to the archive tape from the acquisition SSR. The data is laid-out on the tape using the transverse scan head with tracking and address/length data placed, typically, along the Iongitanal tracks. However, this layout can be varied for differing formats and recording devices. Zero-length records are not generally transfer. In other words, zero-length records are not placed on the archive tape. When the last file record is transferred, the decision step 770 branches to a termination point 780 in the procedure.

As noted above, directory descriptors can be taken from the original acquisition media (SSR memory) or can be generated internally by the host application. Directory descriptor files are generated by the host application if the SSR or other acquisition recorder does not have the ability to generate directory descriptor files directly across the acquisition recorder data interface, or if the operator chooses to archive only a subset of the original data from the SSR Where directory descriptors are generated by the host, the descriptor filesare passed across the archive recorder (OCR) control inteifce to be written to the tape.

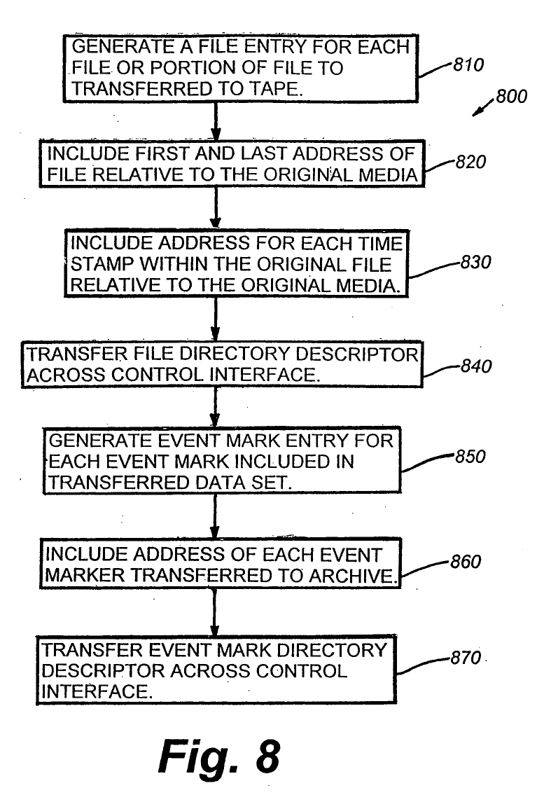

FIG. 8 shows a procedure 800 for handling directory descriptors internally within the application where they cannot be directly retrieved from SSR (acquisition recorder) data. First, according to step 810, a file entry for each file, or a portion of a file, is transferred to the DCR tape (acquisition recorder). Next, according to step 820, the first and last address of the transferred file relative to the original SSR media is placed into the file directory descriptor entry. In addition, according to step 830, the address for each time stamp within the original file relative to the acquisition media (SSR) is provided. Next, according to step 840, the file directory descriptor, now complete, is transferred across the acquisition (SSR) control interface. In step 850, an event mark entry is generated for each event mark that is included in the original SSR data set. The address for each event marker is transferred to the archive tape in step 860. Finally, the event-marked directory descriptor is transferred across the acquisition (SSR) control interface in step 870. In this manner both file directory descriptor information and event mark directory descriptor information are provided directory to the archive tape by the host application itself. Note that this process makes possible the transfer of only a portion of the entire original recording to archive since file directly and event mark directory descriptors having a format understood by the archive tape and associated player are generated and stored.

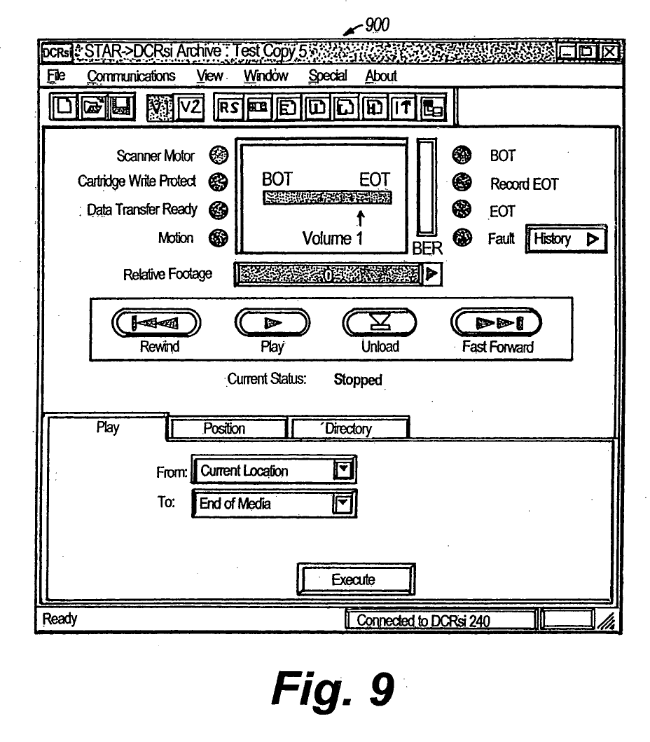

Having discussed in detail data transfer, recovery and playback of archived data is now described. FIG. 9 shows a graphical user interface screen 900 used by the application to enable recovery of archived data stored on tape. The DCR application is adapted to recognize the special longitudinal data on the tape which identifies the DCR as an SSRI When the DCR application recognizes this data, the user is prompted to enter the SSR archive mode provided in the interface screen 900. When the application enters SSR archive mode, the original SSR directory data is recovered off the tape, and a playback control interface is presented. The playback control interface allows the original data to be recovered relative to its original context in the SSR. In archive mode, the application essentially acts as a hybrid controller that allows the DCR to be controlled normally, but playback operations to be specified relative to the original SSR acquisition format. In this archive mode, all SSR control interface functions and directory operations nomrnally present in the SSR controller are supported by the application. In addition, the application can direct the DCR to address the start location for data playback at any word boundary (two-bytes) within the scanned tape. Accordingly, when specifying playback from a specific location relative from the SSR scheme, the playback begins at the same byte location. In addition, because each file is copied as a separate file on the DCR archive tape, each file can be addressed at the correct byte boundary. For the exemplary DCRsi® recorder, playback can only be stopped automatically at the end of the scan of the tape by the DCRsi® recorder. Therefore, stopping after a specific SSR address may cause an overrun on the tape of as much as 4356 bytes. Thisi is a normal. This is the size of a normal block scanned on the tape within the exemplary DCRsi® recorder.

More specifically, the procedure for recovering data from an archive media (DCR tape) is accomplished relative to its original acquisition context, which consist of block address, time code and event marker locations. The data is recovered by first recovering the archive identifier which describes a type of archive made on the tape. Then the original data directory information is recovered. Finally, a deterministic algorithm is applied based on the original directory information to locate specific data on the archive media.

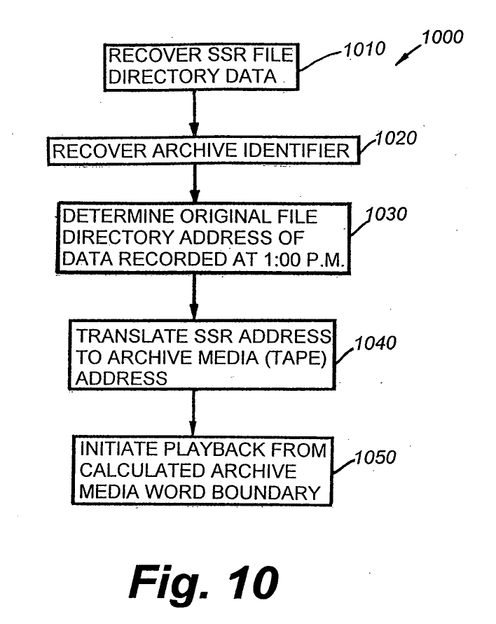

FIG. 10 illustrates a specific example of recovering data recorded on an SSR at 1:00 PM froman archive tape on the DCR. The procedure 1000 is performed by the host application. First, an archive identifier 1010 is recovered. This identifier is of known length and identifies howmany fixed-length records are available for collecting SSR directory information.

According to step 1020, the file directory data for the SSR is recovered. Such data enables the host application to determine if the data was recorded at 1:00 PM.

According to step 1030, the application then determines the original file directory address for data recorded at 1:00 PM. If so, the application proceeds to step 1040 in which the SSR address is translated into a DCR word address. The SSR address is specifically translated as a fixed offset from the end of the SSR directory records whose number and length were identified in the archive identifier. As the DCR can be addressed at any word (two byte) boundary and the SSR addressable block is an even number of bytes, the data at the SSR address recorded at 1:00 PM can be uniquely identified.

Finally, according to step 1050, playback of data from the calculated DCR word boundary in the archive media is initiated. The first byte out of the data interface is the same byte as if the original request (e.g. play from 1:00 PM) had been issued to the SSR containing the same data set.

Note that the use of a single DCR tape or other archive media to store a given set of acquisition data is exemplary. The system and method described herein can be adapted so that multiple (two or more) discrete archive taped (media) can be employed for a single data set. The leader section identifiers on each tape/data set are modified to include a flag that is recognized by the host application as indicating that the given archived data is a subset of the overall archived set. The application can be adapted to measure the size of the overall data set and compare it to the allowable size of the archive media If the acquisition data size is greater than that of the archive media, then the application can determine how many archive tapes (media) are needed, and place an appropriate subset identifier (e.g. “1 of 2,”“4 of 4;”“7 of 9,” etc.) on the leader. The application can prompt for the appropriatetape input when a given data address is requested for playback/manipulation.

It should also be apparent to one of ordinary skill that the transfer of acquisition data to archive media and playback of archived data can be made with respect to any two recording devices using the generalized procedures described herein, in which a deterministic algorithm is used to accomplish transfer of data and associated directories so as to preserve the context of the original acquisition data.

The foregoing had been a detailed description of a preferred embodiment of this invention. Various modifications and additions can be made without departing from the spirit and scope thereof. For example, additional types of directory information, along with the described event and directory identifiers can be employed. In addition, any of the procedures or functions herein can be implemented using hardware, “firmware” or software comprising a computer-readable medium having program instructions executing on a computer a program stepsor a combination of any of these implementations. Finally, while the transfer of data is performed between an SSR and a DCR, the techniques and computer-readable medium implemented herein can be applied to trafers between different types of media platforms. For example a transfer from an optical medium to a solid state medium or from a tape medium to a hard-drive based medium can be accomplished. The terms “DCR” and “SSR” therefore, should be taken broadly to include a variety of alternate recording media where a particular format for recording may vary but the underlying context is desirably preserved. Accordingly, this description is meant to be taken only by way of example and not to otherwise limit the scope of this invention.

What is claimed is:

1. A system for transferring recorded data organired in a first context from an acquisition recorder adapted to store and manipulate the data on an acquisition media based upon the first context to an archive recorder adapted to store and manipulate archive data associated therewith on an archive media organized in a second context comprising:
means for transferring the. recorded data organized in the first context from the acquisition recorder to the archive recorder so that indicated data stored on the archive media organied in the second context;
a host computer interconnected with a control interface of each of the acquisition recorder and the archive recorder, the host computer having an application that operates the archive recorder to store, manipulate and read-archive data stored on the archive recorder and the application being adapted to recognize control information from the acquisition recorder;
means, in the application, for deriving the first context from the acquisition recorder and translating the first context on the acquisition media into a leader in the second context that is recognized by the archive recorder as a preamble to the indicated data; and
means in the application for recognig the leader and enabling recovery data by the archive recorder based upon the leader in a form based upon the first context.

2. The system as set forth in claim 1 wherein the acquisition recorder comprises a solid state recorder and the archive recorder comprises a digital tape recorder, the archive media comprising recording tape.

3. The system as set forth in claim 2 wherein the archive media further includes information with respect to the indicated data that is recorded synchronously with the indicated data in a longitudinal track on the archive media separate from a track along which the indicated data is recorded.

4. The system as set forth in claim 1 wherein the archive media includes special event marker data based upon event markers present in the recorded data.

5. The system as set forth in claim 1 wherein the host computer is physically located in one of either the archive recorder or the acquisition recorder.

6. The system as set forth in claim 1 wherein the host computer is physically loceted remote and separate from each of the archive rcorder and the acquisition recorder.

7. The system as set forth in claim 1 further comprising a graphical user interface, communicating with the host computer, for controlling transfer of the recorded data to the archive media and for enabling playback of the indicated data on the archive media according to predetermined parameters.

8. A method for transferring recorded data from an acquisition media to an archive media comprising the steps of:
reading the recorded data on the acquisition media and extracting information in a first context with respect to the recorded data;
recording identifying information on the archive media having parameters relating to the recorded data in a second context, including recording a leader on the archive media for subsequent playback in a format related to the acquisition media; and
transferring the recorded data to the archive media as indicated data.

9. The method as set forth in claim 8 wherein the step of recording the identifying information further comprises recording an identifying information track on the archive media synchronously with a track on the archive media containing the indicated data.

10. The method as set forth in claim 9 further comprising playing back the indicated data based upon the identityg information in each of the leader and the identifying information track.

11. The method as set forth in claim 10 wherein each of the steps of transferring the recorded data and playing back the indicated data include manipulating a graphical user interface adapted to display predetermied markers and information related to the indicated data.

12. A method for recovering archive data from an archive media, transferred to the archive media from a source acquisition media, comprising the steps of:
reading identifying information on the archive media with respect to indicated data onthe archive media and determining a relative value of the indicated data with respect to the source acquisition media; and
playing back the indicated data based upon the identifying information.

13. The method as set forth in claim 12 wherein the step of reading the indicating information includes reading each of a leader on the archive media and an identifying information track on the archive media synchronous with a track on the archive media containing the indicated data.

14. A method for handling recorded data comprising the steps of:
transferring data in a first context from an acquisition media to an archive media so as to be stored in a second context as indicated data, including providing identifying information; and
reading the identifying information and recovering the indicated data based upon the identifg information in a format related to the acquisition media.

15. The method as set forth in claim 14 wherein the step of transferring includes providing identiying information of the archive media as a leader to the indicated data and providing an identifying information track recorded synchronously on the archive media with a track on the archive media containing the indicated data.

16. The method as set forth in claim 15 wherein the step of transferring includes transferring the data from a solid state acquisition media to a tape archive media.

17. The method as set forth in claim 15 wherein the step of providing identifying information includes providing time-based information and special event markers based upon respective time and event information in the acquisition media.
